(19) United States
(12) Patent Application Publication
(10) Pub. No.: US 2006/0144992 A1
(43) Pub. Date: Jul. 6, 2006

(54) Transformable fluid foil with pivoting spars

(76) Inventors: Akhllesh K. Jha, Oceanside, CA (US); David L. Cowen, Lakewood, CA (US)

Correspondence Address: c/o Gerald Andersen;Ste 400, 2780 Skypark Drive, Torrance, CA, 90505, US

(21) Appl. No.: 11/007,726

(22) Filed: Dec. 7, 2004

(51) Int. Cl. B64C 3/38

(52) U.S. Cl. 244/46

(57) ABSTRACT

An adjustable fluid foil. The fluid foil includes a foil support structure having one more spars. A first mechanism facilitates mounting the one or more spars to one or more supports. The one or more spars are independently controllable and form a frame that is covered with a deformable skin. A second mechanism provides a control signal, and a third mechanism selectively rotates the first mechanism based on the control signal, thereby reorienting the one or more spars and implementing desired changes in fluid foil characteristics. In a specific embodiment, the spars are telescoping spars that are responsive to control signals from the second mechanism, and the spars exhibit strategically different shapes to facilitate wing camber adjustments in response to reorientation of the one or more spars.

This invention was made with Government support under Defense Advanced Research Projects Agency (DARPA) Contract No. F33615-02-C-3257. The Government may have certain rights in this invention.

### BACKGROUND OF THE INVENTION

1. Field of Invention

This invention relates to fluid foils. Specifically, the present invention relates adjustable fluid foils, such as morphing-aircraft airfoils.

2. Description of the Related Art

Fluid foils are employed in various demanding applications including airplane and boat propellers, helicopter blades, and aircraft wings. Such applications often demand versatile fluid foils that can efficiently accommodate various operating conditions.

Versatile fluid foils are particularly important in aircraft applications. Aircraft often encounter various operating conditions that demand different airfoil performance characteristics. For example, while a loitering and low-speed flight demands wings with high aspect ratios and low sweep angles for increased lift-to-drag ratio, a high-speed flight condition usually requires highly swept-back low-area wings for reduced wave drag. Therefore, an aircraft wing planform is usually optimized for a particular mission type. Consequently, different types of aircraft must be purchased to meet different demands, which is costly. For example, a military may purchase several different types of aircraft, such as fighters, surveillance aircraft, and so on. This increases operational costs and reduces the military's efficiency and lethality.

Conventionally, airfoil performance characteristics are adjusted via controllable surfaces, such as wing flaps. Unfortunately, flaps often provide small planform changes and lack sweep-angle adjustability. Consequently, flaps alone typically do not enable aircraft to optimally perform multiple types of missions requiring radically different wing geometries.

To overcome limitations of conventional flaps, adjustable wings, also called morphing wings or transforming wings, are employed. An exemplary adjustable wing is disclosed in U.S. Pat. No. 6,622,974, entitled GEOMETRIC MORPHING WING WITH EXPANDABLE SPARS, by Dockter et al., issued Sep. 23, 2003, and assigned to The Boeing Company. The morphing wing employs an inflatable spar positioned within the wing. Wing camber is adjusted by inflating or deflating the spar. Unfortunately, the morphing wing has relatively limited ability to drastically change important wing characteristics, such as wing sweep. Furthermore, additional safeguards may be required to prevent bladder leakage and to provide sufficient wing rigidity, which may complicate the design and increase costs.

An alternative morphing wing is disclosed in U.S. Pat. No. 5,899,410, entitled AERODYNAMIC BODY HAVING COPLANAR JOINED WINGS, by Timothy M. Garrett, issued May 1, 1999 and assigned to McDonnell Douglas Corporation. This morphing wing enables wing sweep adjustments but lacks substantial wing area adjustment capability. Furthermore, the wings are mechanically linked so that actuation of one wing causes actuation of the other. Hence, wings on one side of the aircraft must maintain similar configurations as corresponding wings on the opposite side of the aircraft. This limits overall aircraft controllability. Furthermore, the accompanying aircraft requires at least four wings, including a forward wing and an aft wing on each side of the aircraft. These additional wings and accompanying edges may undesirably complicate flight characteristics, which may increase aircraft design, implementation, and pilot-training costs.

An alternative telescoping wing is disclosed in U.S. Pat. No. 4,824,053, entitled TELESCOPING WING, by Branko Sarh. The wing employs a flexible or sliding skin structure disposed over telescoping spars. The telescoping spars include rotatable and non-rotatable overlapping spar sections. Unfortunately, such use of interconnected alternating rotatable and non-rotatable spars necessitates complex mechanisms to stabilize the fixed sections relative to the rotatable sections and to rotate the rotatable sections. Implementation may require undesirably bulky ring gears, motors, worm gears, and toothed belts. Furthermore, if one spar jams, the remaining spars may also jam, or the motors driving the other spars may cause uneven spar extension, thereby destroying the wing.

An alternative morphing aircraft wing is disclosed in U.S. Pat. No. 6,045,096, entitled VARIABLE CAMBER AIRFOIL, by Rinn, et al. This airfoil incorporates a flexible skin and a movable internal structure to enable changes in airfoil camber. Unfortunately, this airfoil does not facilitate airfoil sweep adjustments or substantial changes in airfoil area.

Morphing aircraft wings also include variable-sweep wings, which are currently employed in certain military aircraft to improve the critical Mach number and reduce high-speed drag to facilitate supersonic flight. One variable-sweep wing is disclosed in U.S. Pat. No. 5,671,899, entitled AIRBORNE VEHICLE WITH WING EXTENSION AND ROLL CONTROL, by Nicholas, et al. and assigned to Lockheed Martin Corporation. While this morphing aircraft wing enables changes in wing sweep and roll, it does not enable substantial changes in wing area, which limits its adaptability to varying flight conditions, such as loitering.

Another exemplary variable-sweep wing is disclosed in U.S. Pat. No. 6,073,882, entitled FLYING VEHICLE WITH RETRACTABLE WING ASSEMBLY, issued Jun. 13, 2000. The retractable wing assembly employs pivoting nesting wing vanes or fins that are supported by a vane support member. The vane support member may be repositioned via an articulating assembly to fold and unfold the wing assembly. Unfortunately, the wing assembly requires potentially problematic links between vanes, and the links may restrict the vanes to certain positions. Furthermore, the large numbers of requisite interconnected links and levers may be complex to implement and undesirably prone to fatigue.

Various additional variable-sweep wings are disclosed in U.S. Pat. Nos. 1,215,295 (Issued Feb. 6, 1917), 2,744,698 (Issued May 8, 1956), 3,064,928 (Issued Nov. 20, 1962), 3,092,355 (Issued Jun. 4, 1963), 3,330,501 (Issued Jul. 11, 1967), 3,481,562 (Issued Dec. 2, 1969), 3,654,729 (Issued Apr. 11, 1972), 3,738,595 (Issued Jun. 12, 1973), 3,662,974 (Issued May 16, 1972), 3,738,595 (Issued Jun. 12, 1973), 3,971,535 (Issued Jul. 27, 1976), and 5,992,796 (Issued Nov. 30, 1999). Generally, these U.S. patents describe folding wings or wings having sections that fold into themselves or into slots in an accompanying aircraft fuselage. Unfortunately, these variable-sweep wings, which are often adapted for supersonic flight, typically cannot efficiently or independently adjust various wing characteristics, such as wing shape and area. Consequently, they often exhibit limited performance at low speeds and may require additional special control surfaces, such as flaps and ailerons, to facilitate flight maneuvers.

Accordingly, conventional morphing wings and fluid foils often provide limited configurations and are often undesirably complex or expensive to implement.

Hence, a need exists in the art for an efficient, configurable, and cost-effective fluid foil that may efficiently adjust to accommodate various operating conditions.

### SUMMARY OF THE INVENTION

The need in the art is addressed by the adjustable fluid foil of the present invention. In the illustrative embodiment, the inventive fluid foil is employed as a transformable aircraft wing. The fluid foil includes a foil support structure having one more spars and a first mechanism for mounting the one or more spars to one or more supports. The one or more spars are independently controllable and form a frame that is covered with a deformable skin, such as a sliding or flexible skin. A second mechanism provides a control signal. A third mechanism selectively rotates the first mechanism or a portion thereof in response to the control signal to reorient the one or more spars to implement one or more desired changes in one or more characteristics of the fluid foil.

In a specific embodiment, the spars are telescoping spars that selectively telescope in response to control signals from the second mechanism, and the deformable skin is an elastomeric or sliding skin. The first mechanism includes a rotatable mounting system having one or more pivot connectors each attached to corresponding spars. The third mechanism includes one or more motors capable of rotating the one or more pivot connectors. The one or more motors are responsive to separate control signals from the second mechanism, which includes a controller that provides the separate control signals to the one or more motors. A fourth mechanism selectively locks positions of the one or more spars. The fourth mechanism includes one or more locks adapted to lock the pivot connectors in response to control signals from the controller.

In an illustrative embodiment, the adjustable fluid foil further includes an input system in communication with the controller. The input system provides information pertaining to an operating environment of the fluid foil. The input system includes one or more sensors, buttons, or levers that provide signals to the controller to effect desired changes in fluid foil characteristics.

In various specific embodiments, the adjustable fluid foil is a transformable airfoil on an aircraft that includes plural of the airfoils. The one or more supports includes a fuselage of the aircraft. The wings of the aircraft are implemented via the airfoils. The one or more spars have strategically varying heights so that wing camber changes may be implemented via the third mechanism by selectively rotating one or more of the pivots to sweep certain spars. The spars also have strategically varying lengths.

In one embodiment, the one or more pivots are approximately concentric. In another embodiment, the one or more pivots are spatially or linearly distributed. The rotatable mounting system includes one or more beams or rods extending between pivot connectors of opposing wings. Furthermore, the controller is adapted to enable asymmetrical control of the aircraft by enabling independent control of each of the airfoils.

The novel design of one embodiment of the present invention is facilitated by the use of the third mechanism to selectively rotate spars of a fluid foil covered with a transformable skin. By selectively rotating spars on an aircraft, various flight characteristics, such as wing span, chord, sweep, area, and camber may be controlled to yield drastic changes in wing characteristics. This enables transformable wings to be optimally adapted to meet flight requirements and may further obviate the need for conventional airfoil control surfaces, such as flaps and ailerons.

### BRIEF DESCRIPTION OF THE DRAWINGS

FIG. 1 is a diagram of an aircraft employing adjustable wings in a first configuration according to an embodiment of the present invention.

FIG. 2 is a diagram of the aircraft of FIG. 1 employing the adjustable wings in a second configuration.

FIG. 3 is a top view of the aircrafts of FIGS. 1 and 2 illustrating an exemplary asymmetric wing configuration for implementing an aircraft maneuver.

FIG. 4 is a more detailed diagram illustrating a system for mounting and controlling the adjustable wing spars of FIGS. 1-3.

FIG. 5 is a diagram of an alternative embodiment of the aircraft of FIGS. 1-4 showing distributed spar pivot connectors.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

For the purposes of the present discussion, a fluid is any substance, gas, or beam of particles that flows, such as in response to application of a predetermined force, such as a shearing stress. A shearing stress occurs whenever a force acts tangential to a surface. Accordingly, air, water, and solar plasma are all considered fluids.

A fluid foil is any surface designed to manipulate fluid flow. Fluid foils include boat motor propellers, boat sails, solar sails for spacecraft applications, cement mixer blades, and airfoils, such as missile-steering fins and aircraft wings. An airfoil is a fluid foil that is adapted to manipulate airflow.

A deformable skin is a covering with an outer shape and/or surface area that may adapt to accommodate geometrical changes in a structure that supports and/or is covered by the skin. Consequently, sliding skins, and various flexible skins, such as elastomeric skins, are considered deformable skins.

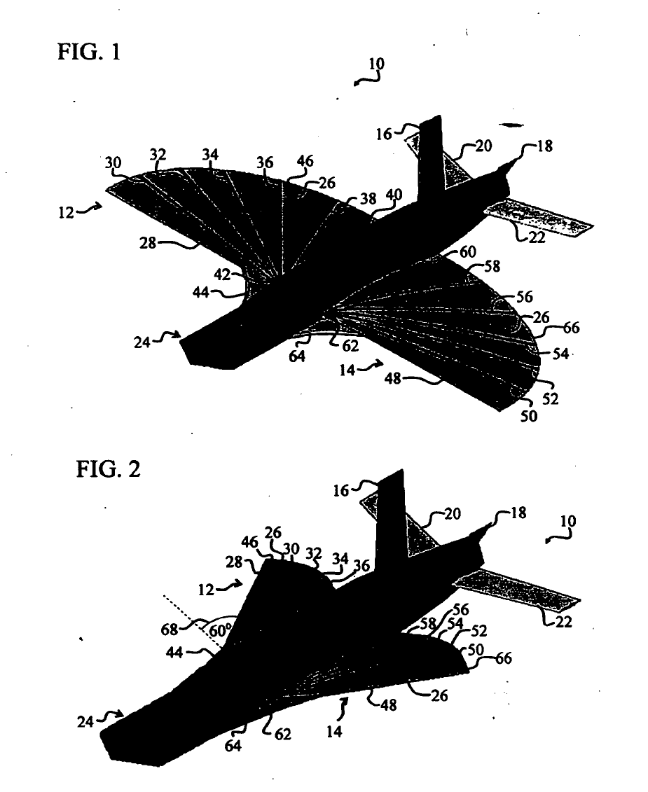

FIG. 1 is a diagram of an aircraft 10 employing fluid foils as adjustable wings 12, 14 in a first configuration according to an embodiment of the present invention. For clarity, various features, such as power supplies and propulsion systems, have been omitted from the figures. However, those skilled in the art with access to the present teachings will know which components and features to implement and how to implement them to meet the needs of a given application.

The aircraft 10 includes a first transformable wing 12 and a second transformable wing 14, which are mounted to right and left sides an aircraft fuselage 24, respectively, as seen looking from the rear of the aircraft 10 toward the nose. A first angled tail fin 16 and a second angled tail fin 18 are mounted to the fuselage 24 near the rear of the fuselage 24. Bases of the angled tail fins 16, 18 are offset to the right and left of the centerline of the fuselage 24, respectively, and are angled approximately 80° relative to a plane formed by the wings 12, 14.

A first near-horizontal stabilizer 20 and a second near-horizontal stabilizer 22 are mounted aft of the angled tail fins 16, 18 and extend from right and left sides of the fuselage 24, respectively. The various mounting positions and angles of the airfoils 12-22 may be altered without departing from the scope of the present invention.

The first transformable wing 12 includes seven rotatable spars 28-40, including a first leading-edge spar 28, a second spar 30, a third spar 32, a fourth spar 34, a fifth spar 36, a sixth spar 38, and a seventh trailing-edge spar 40. The spars 28-40 are mounted at a first pivot connector 42 from which they extend. The pivot connector 42 is mounted to the fuselage 24 aft of a first leading-edge junction 44 that provides a leading wing edge near the fuselage 24 and protects the pivot connector 42.

The spars 28-40 are covered with a deformable skin 26 that forms the aerodynamic surface of the first wing 12. The deformable skin 26 is a flexible skin in the present specific embodiment. The flexible skin 26 may be implemented via an elastomeric skin or other type of deformable skin, such as a sliding or telescoping skin, without departing from the scope of the present invention.

In the present configuration, the skin 26 covers the leading-edge spar 28, thereby providing a leading edge of the first wing 12. Alternatively, the first leading-edge spar 28 alone may form the leading edge of the first transformable wing 12. The skin 26 also forms an end-edge 46 of the first transformable wing 12, which also acts as a trailing edge in the present configuration. In an alternative configuration, the seventh trailing-edge spar 40 may be rotate forward, resulting in a tailing edge formed by the trailing-edge spar 40, as discussed more fully below.

The second transformable wing 14 is similar to the first transformable wing 12. The second transformable wing 14 includes rotatable spars 48-60, which correspond to spars 28-40 of the first transformable wing 12. Similarly, the second transformable wing 14 includes a second pivot connector 62 and a second leading-edge junction 64, which correspond to the first pivot connector 62 and the first leading-edge junction 42 of the left transformable airfoil 12, respectively. The various first-wing spars 28-40 and second-wing spars 48-60 together act as wing frames.

In operation, a controller running on the aircraft 10 issues control signals in response to control input from a pilot, receiver, sensor, or other device or system, as discussed more fully below. The control signals selectively actuate the pivot connectors 42, 62, which rotate the spars 28-40, 48-60 into desired orientations.

In the present specific embodiment, the spars 28-40, 48-60 are horizontally rotatable, enabling the airfoils 12, 14 to selectively fan in and fan out in response to appropriate control signals. Alternatively, each spar 28-40, 48-60 may be connected to a pivot connector (not shown) that enables three degrees of rotational freedom, so that the vertical cross-sectional profile of the wings 12, 14 may be adjusted. In the present embodiment, each spar 28-40, 48-60 is independently controllable.

The rotatable spars 28-40, 48-60 and accompanying transformable skin 26 enable drastic adjustments in various wing characteristics, including chord, sweep angle, wing area, and chamber, as discussed more fully below. Unlike conventional transformable wings, various wing characteristics may be adjusted independently, such that one characteristic may be adjusted without adjusting the other characteristics. Furthermore, the spars 28-40, 48-60 may be telescoping spars, which would enable independent changes in wing span. This enhanced controllability of wing characteristics enables the aircraft 10 to efficiently and more optimally adapt to changing operating conditions or mission requirements than conventional aircraft.

When the transformable wings 12, 14 are extended in the first configuration of FIG. 1, they form an approximate semi-ellipse. The semi-ellipse results from the trailing spars 30-40, 50-60 being successively shorter. If the trailing spars were equal in length to the leading-edge spars 28, 48, the wings 12, 14 would exhibit a more semi-circular footprint. The exact wing footprint and the exact lengths of the spars 28-40, 48-60 are application specific and may be adjusted to meet the needs of a given application without departing from the scope of the present invention.

The shapes of the end-edges 46, 66 may be adjusted by varying spar lengths and by selectively sweeping the spars 28-40, 48-60. To increase airfoil sweep angle, the leading-edge spars 28, 48 are rotated aft as desired. The trailing edges of the airfoils 12, 14 may be changed by rotating the end spars 40, 60 forward, as discussed more fully below.

The aircraft 10 may be implemented as a missile or other type of aircraft without departing from the scope of the present invention. For the purposes of the present discussion, the term aircraft refers to any object or collection of objects that flies through the air. The airfoils 12, 14 are particularly useful in guided munitions applications, such as guided missiles. The airfoils 12, 14 could be used as missile steering fins.

FIG. 2 is a diagram of the aircraft 10 of FIG. 1 employing the adjustable wings 12, 14 in a second configuration. With reference to FIGS. 1 and 2, the spars 28-38 of the first transformable wing 12 and the spars 48-58 of the second transformable wing 14 are rotated back so that the airfoils 12, 14 of FIG. 2 exhibit a 60° sweep angle 68.

The transformable wings 12, 14 in the first configuration of FIG. 1 are not swept back. The second swept-back configuration of FIG. 2 facilitates high-speed flight and/or diving maneuvers. The first configuration of FIG. 1 facilitates slow-speed operation, which may be desirable for aerial loitering, such as for aerial reconnaissance operations or for landing. By selectively sweeping the transformable wings 12, 14 via the rotatable spars 28-40, 48-60, various wing characteristics, such as sweep angle, area, and wing span, may be drastically changed to meet in-flight demands.

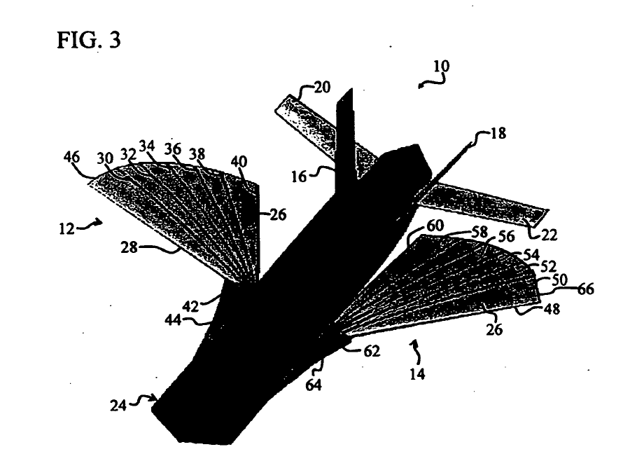

FIG. 3 is a top view of the aircrafts 10 of FIGS. 1 and 2 illustrating an exemplary asymmetric wing configuration for implementing an aircraft maneuver. The first transformable wing 12 is swept back approximately 10°, and the trailing-edge spar 40 is rotated approximately 35° off the fuselage 24. Hence, the first transformable wing 12 subtends an angle of approximately 45° at the first pivot connector 42.

The second transformable wing 14 is swept back approximately 40°, while the second trailing edge spar 60 is rotated approximately 5° off the fuselage 24. Hence, the second transformable wing 14 also subtends an angle of approximately 45°.

By selectively rotating the trailing-edge spars 40, 60 against the fuselage 24, the end edges 46, 66 of the airfoils 12, 14 are converted to trailing edges. Trailing edges formed by the trailing-edge spars 40, 60 only become trailing edges when the trailing-edge spars 40, 60 are rotated off the fuselage 24.

The different sweep angles of the first transformable wing 12 and the second transformable wing 14 associated with leading-edge spars 28, 26 and trailing-edge spars 40, 60, respectively, result in asymmetrical flight characteristics. The resulting asymmetries may be strategically chosen in accordance with a predetermined algorithm running on a controller of the aircraft 10 to facilitate specific flight maneuvers. Details of the controller and algorithm are application specific and may be readily determined and implemented by those skilled in the art with access to the present teachings and without undue experimentation. The ability to implement differential changes in wing characteristics between the first wing 12 and the second wing 14 may obviate the need for conventional flight-control surfaces, such as ailerons.

The table below lists certain airfoil characteristics for the various configurations of FIGS. 1-3, when the spars 28-40, 48-60 have length R.

TABLE 1

| Configuration | Wing Sweep | Wing Span | Wing Area |
|---|---|---|---|
| | 0° | 2R | πR²/2 |
| | 60° | R | πR²/6 |
| | First wing: 10° | Rsin(80°) + | πR²/4 |
| | | Rsin(50°) ≅ 1.75R | |
| | Second wing: 40° | | |

Hence, wing area may be drastically changed by 200%. Wing span changes by 100%; wing sweep changes from 0° to 60°; and the wing aspect ratio changes 300% by rotating the spars according to embodiments of the present invention.

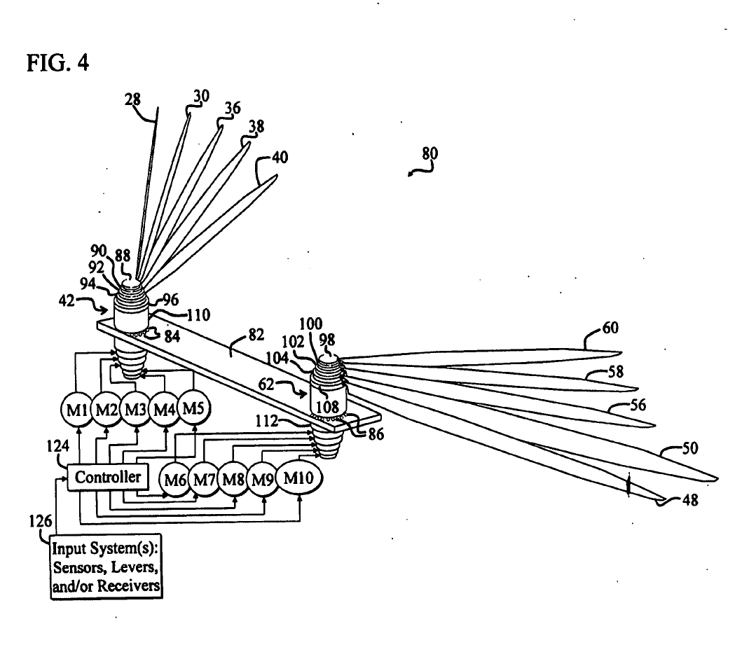

FIG. 4 is a more detailed diagram illustrating a system 80, which acts as a foil support structure for mounting and controlling the adjustable wing spars 28-40, 48-60 of FIGS. 1-3. For clarity, various aircraft components, such as the fuselage 24 and transformable skin 26 of the aircraft of FIGS. 1-3 is are not shown in FIG. 4. In the embodiment of FIG. 4, the first spars 32, 34 and the second spars 52, 54 are also omitted. Those skilled in the art will appreciate that the exact number of wing spars is application specific. A single rotatable spar may be employed without departing from the scope of the present invention.

The first pivot connector 42 includes five independently rotatable concentric sections 88, 90, 92, 94, 96 to which are mounted to five first-wing spars 28, 30, 36, 38, 40, respectively. The five independently rotatable concentric sections 88-96 extend through a horizontal support beam 82 to respective motor drives M1-M5. The five motors M1-M5 receive control input from a controller 124, which receives input from an input system 126. The input system 126 may include sensors, levers, receivers, and so on.

In the present embodiment, the last independently-rotatable concentric section 96 accommodates a first set of bearings between the last concentric section 96 and the horizontal support beam 82. The bearings 84 enable rotation of the pivot connector 42 attached to the last concentric section 96 but prevent lateral or longitudinal displacement relative to the support beam 82. Additional bearings (not shown) between the five independently rotatable sections 88-96 enable relative rotation but inhibit axial or horizontal displacement relative to each other.

Similarly, the right pivot connector 62 includes five independently rotatable concentric sections 98, 100, 102, 104, 106 to which are mounted five corresponding second-wing spars 48, 50, 56, 58, 60, respectively. The rotatable sections 98-106 are selectively actuated via five corresponding second-wing motors M6-M10, which are responsive to control signals from the controller 124.

The second pivot connector 62 is also connected to the horizontal support beam 82 at second bearings 86, which prevent displacement but enable rotation of the second pivot connector 62. The horizontal support beam 82 may be readily mounted to a fuselage frame, such as via bolts, welds, and/or via other well known methods to provide sufficient in-flight stability. The pivot connectors 42, 62 and the associated horizontal support beam 82 represent a rotatable mounting system adapted to rotate the spars 28-40, 48-60 to effect desired changes in airfoil characteristics.

In operation, the controller 124 provides control signals to each of the motors M1-M10 as need to implement a given flight maneuver or to respond to certain flight conditions as determined via input from the sensor system 126 and in accordance with flight-control software running on the controller 124. The angular position of each spar 28-40, 48-60 may be independently controlled via each motor M1-M10.

Wing cross-sectional shape or camber may be strategically changed by fixing certain spars and moving the remaining spars. Employing spars of strategically different heights facilitates optimization of vertical cross-sectional wing shape, i.e., camber, in response to selective movement of individual spars. For example, in the present embodiment, the second spar 50 of the second-wing spars 48-60 is vertically thicker than the remaining right-wing spars 48, 56, 58, 60. If, for example, the second-wing leading-edge spar 48 and the corresponding trailing-edge spar 60 remain fixed, desired wing camber changes may be implemented by selectively rotating the second spar 50, and/or the remaining spars 58, 56. The synergistic ability to further control wing chamber via the same rotatable spars 28-40, 48-60 and accompanying mechanisms 42, 62, 124, M1-M10 employed to adjust wing area, sweep, and span, provides further significant wing-adjustment and optimization capabilities.

In the present specific embodiment, the controller 124 is implemented via a computer running application-specific flight-control software that may be readily developed by those skilled in the art with access to the present teachings and without undue experimentation. However, note that the controller 124 may be implemented via mechanical linkages or gearing that is selectively responsive to levers or other devices that may be remotely, automatically, or manually activated, such as by a pilot.

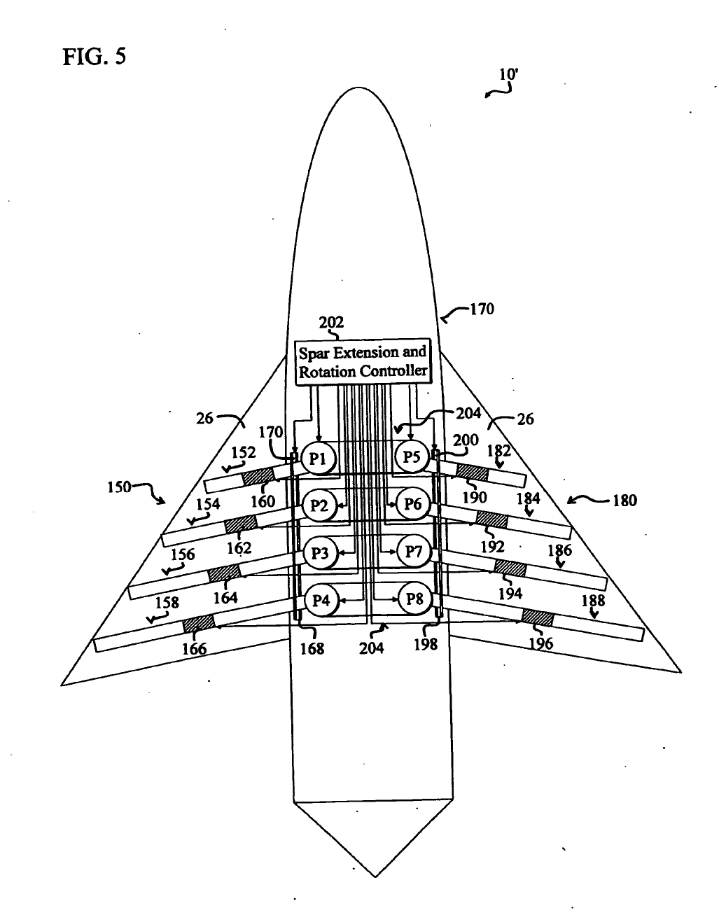

FIG. 5 is a diagram of an alternative embodiment 10′ of the aircraft 10 of FIGS. 1-4 showing distributed spar pivot connectors P1-P8. The alternative morphing aircraft 10′ of FIG. 5 employs a left transformable wing 150 and a right transformable wing 180, which are mounted to a fuselage 170.

The left transformable wing 150 includes four variable-length, i.e., telescoping spars 152-158, each equipped with left-wing telescoping actuators 160-166, respectively. The left-wing telescoping spars 152-158 are pivotally mounted to pivot connectors P1-P4, respectively. The actuating pivot connectors P1-P4 act as rotary actuators that selectively rotate the respective spars 152-158 in response to control signals from a spar extension and rotation controller 202 positioned within the fuselage 170. Similarly, the left-wing telescoping actuators 160-166 selectively lengthen or shorten the respective spars 152-158 in response to telescoping control signals from the spar extension and rotation controller 202.

A left-wing break 168 selectively clamps and locks the left-wing telescoping spars 152-158 into position in response to locking signals from the spar extension and rotation controller 202. The left-wing break 168 provides a break slot 170 in which the left-wing telescoping spars 152-158 may slide, which improves spar stability. To lock the spars 152-158 into position, the left-wing break 168 tightens, sufficiently narrowing the slot 170 to prevent spar motion within the slot 170.

The right transformable wing 180 is similar to the let transformable wing 150 and includes right-wing spars 182-188 equipped with right telescoping actuators 190-196 respectively, which are analogous to the left-wing spars 152-158 and the respective left-wing telescoping actuators 160-166, respectively. Similarly, the right transformable wing 180 includes four actuating pivot connectors P5-P8, a right-wing break 198 and associated right break slot 200, which are analogous to the left-wing pivot connectors P1-P4 and the left-wing break 168 and slot 170, respectively.

The left-wing pivot connectors P1-P4 and the right-wing pivot connectors P5-P8 are further stabilized via horizontal support beams 204 that extend between the front left-wing pivot connector P1 and the front right-wing pivot connector P4; between the second left-wing pivot connector P2 and the second right-wing pivot connector P6; between the third left-wing pivot connector P3 and the corresponding third right-wing pivot connector P7; and between the aft left-wing pivot connector P4 and the aft right-wing pivot connector P8. The horizontal support beams 204 are fixed to a frame (not shown) of the aircraft 10′, such as via bolts, welds, or other suitable connections.

The horizontal support beams 204 may be replaced with another type(s) of support structure(s) without departing from the scope of the present invention. For example, the pivot connectors P1-P8 may be mounted on a single stabilizing platform (not shown), or the beams 204 may be joined via an additional vertical support beam (not shown).

In the present embodiment, the left-wing pivot connectors P1-P4 are linearly distributed as are the right-wing pivot connectors P5-P8. Another type of distribution, such as a nonlinear distribution or volumetric distribution of pivot connectors and spars may be employed without departing from the scope of the present invention.

The wings 150, 180 are covered with the transformable skin 26, such as an elastomeric skin or a sliding skin. Transformable skins are discussed more fully in co-pending U.S. patent application Ser. No. ______, filed ______, entitled TRANSFORMABLE SKIN, the teachings of which are herein incorporated by reference.

In operation, the spar extension and rotation controller 202 determines a desired flight configuration based on a predetermined algorithm and/or via input from a pilot or other system (not shown). The spar extension and rotation controller 202 then issues appropriate signals to the various actuators P1-P8, 160-166, 190-196, 168, 198 to implement the desired configuration, which may be optimized for a particular operating environment or mission segment.

The spar extension and rotation controller 202 may be responsive to input from a ground station, sensor suite, or other system without departing from the scope of the present invention. Furthermore, the spar extension and rotation controller 202 may be implemented via a remote station. In this case, a receiver (not shown) positioned on or within the aircraft 10′ would relay control signals to appropriate actuators P1-P8, 160-166, 190-196, 168, 198. The various actuators P1-P8, 160-166, 190-196, 168, 198 may be readily developed or purchased by those skilled in the art with access to the present teachings.

Like the aircraft 10 of FIGS. 1-3, the aircraft 10′ of FIG. 5 enables independent control of various wing characteristics, such as wing area, sweep, and camber. The telescoping spars 152-158, 182-188 further enable independent control of wing span.

Various features of the aircraft 10′ of FIG. 5 may be implemented in the embodiments of FIGS. 1-4 without departing from the scope of the present invention. For example, the breaks 168, 198 and the telescoping actuators 160-166, 190-196 may be readily adapted to the embodiments of FIGS. 1-4 without departing from the scope of the present invention.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

What is claimed is:

1. An adjustable fluid foil comprising:
first means for mounting plural spars to one or more supports, said plural spars being independently controllable and forming a frame that is covered with a deformable skin;
second means for providing a control signal; and
third means for selectively rotating or pivoting said first means or a portion thereof in response to said control signal to reorient said one or more spars to implement one or more desired changes in one or more characteristics of said fluid foil.

2. The fluid foil of claim 1 wherein said plural spars have varying dimensions that facilitate wing camber adjustments in response to angular adjustments of one or more of said plural spars.

3. The fluid foil of claim 2 wherein said plural spars include means for selectively telescoping in response to control signals from said second means.

4. The fluid foil of claim 2 wherein said deformable skin is an elastomeric skin.

5. The fluid foil of claim 2 wherein said first means includes a rotatable mounting system having one or more rotatable sections each attached to corresponding spars of said plural spars.

6. The fluid foil of claim 5 wherein said third means includes one or more motors capable of rotating said one or more rotatable sections.

7. The fluid foil of claim 6 wherein said one or more motors are responsive to control signals from said second means, said control signals facilitating independent rotation of each of said one or more rotatable sections to facilitate independent positioning of each of said plural spars.

8. The fluid foil of claim 7 further including fourth means for selectively locking positions of one or more of said plural spars.

9. The fluid foil of claim 8 wherein said fourth means includes one or more locks adapted to lock said rotatable sections in response to control signals from said controller.

10. The fluid foil of claim 7 further including an input system in communication with said controller, said input system providing information pertaining to an operating environment of said fluid foil.

11. The fluid foil of claim 10 wherein said input system includes one or more sensors, buttons, or levers that provide signals to said controller to effect desired changes in fluid foil characteristics.

12. The fluid foil of claim 7 wherein said fluid foil is an airfoil on an aircraft.

13. The airfoil of claim 12 wherein said aircraft includes plural of said airfoils, and wherein said one or more supports includes a fuselage of said aircraft, and wherein wings of said aircraft are implemented via said airfoils, said airfoils lacking ribs.

14. The airfoil of claim 13 wherein said plural spars include spars having strategically varying heights so that wing camber changes may be implemented via said third means by selectively rotating one or more of said rotatable sections to sweep certain spars.

15. The airfoil of claim 14 wherein said plural spars includes a trailing-edge spar positioned so that sweep angle of a trailing edge of said airfoil changes in response to movement of said trailing-edge spar.

16. The airfoil of claim 13 wherein said one or more pivot connectors are approximately concentric.

17. The airfoil of claim 13 wherein said one or more pivot connectors are spatially or linearly distributed.

18. The airfoil of claim 13 wherein said rotatable mounting system includes one or more beams or rods extending between one or more rotatable sections on opposing wings.

19. The airfoil of claim 13 wherein said controller is adapted to enable asymmetrical control of said aircraft by enabling independent control of each of said airfoils.

20. A transformable airfoil comprising:
a frame having a spar;
a rotatable mounting system to which one end of said spar is mounted;
a control system for selectively controlling said rotatable mounting system to selectively reorient said spar; and
a deformable surface disposed over said frame and secured relative to said frame so that activation of said control system is sufficient to selectively alter characteristics of said airfoil.

21. The airfoil of claim 20 further including means for facilitating independent control of sweep angle of a leading edge and sweep angle of a trailing edge of said airfoil, thereby enabling control of airfoil area independent of sweep angle of a leading edge of said airfoil.

22. The airfoil of claim 21 further including means for enabling control of wing span independently of wing sweep, said means for enabling including means for selectively telescoping said spar.

23. The airfoil of claim 21 further including means for allowing control of wing chamber independently of wing sweep and area, said means for allowing including means for selectively fixing a leading edge spar and a trailing edge spar and rotating intervening spars positioned therebetween.

24. An adjustable fluid foil comprising:
a frame having a first spar and a second spar;
a deformable surface disposed over said frame;
a rotatable mounting system to which one end of said first spar and one end of said second spar is mounted; and
a control system for selectively controlling said rotatable mounting system to reorient said first spar and said second spar to selectively change area and sweep angles associated with said fluid foil by selectively adjusting leading and trailing edges of said fluid foil.

25. The fluid foil of claim 24 further including means for selectively converting an end edge of said fluid foil to a trailing edge of said fluid foil in response to one or more control signals from said control system.

26. The fluid foil of claim 24 wherein said adjustable fluid foil is an aircraft airfoil.

27. The fluid foil of claim 26 wherein said rotatable mounting system includes a first rotatable section and a second rotatable section, said first spar mounted to said first rotatable section, said second spar mounted to said second rotatable section.

28. The fluid foil of claim 27 wherein said control system includes first means for independently controlling area of said fluid foil and sweep angle of a leading edge and a trailing edge of said fluid foil.

29. The fluid foil of claim 28 wherein said first means includes a motor in communication with a controller, said motor capable of independently actuating said first rotatable section and said second rotatable section in response to control signals from said controller.

30. The fluid foil of claim 29 further including plural spars mounted between said first spar and said second spar on said mounting system, and wherein the orientation of said fist spar and the orientation of said second spar determine leading-edge sweep angle and trailing-edge sweep angle, respectively, of said airfoil.

31. The fluid foil of claim 30 wherein said plural spars are mounted concentrically on independently controllable rotatable sections of said mounting system.

32. The fluid foil of claim 31 wherein said aircraft airfoil is a first wing on an aircraft, said aircraft further including a second wing, said first wing and said second wing connected to one or more support structures extending from one or more rotatable sections on said first wing to one or more rotatable sections on said second wing.

33. The fluid foil of claim 31 wherein said one or more support structures include one or more beams or rods that incorporate bearings to enable rotation of said rotatable sections on said first and second wings relative to said one or more support beams or rods.
